(19) United States
(12) Patent Application Publication
(10) Pub. No.: US 2012/0045550 A1
(43) Pub. Date: Feb. 23, 2012

(54) PROCESS TO PREPARE A LOW-SODIUM SALT PRODUCT, PRODUCT OBTAINABLE THEREBY AND THE USE THEREOF

(75) Inventors: Gerrit Jan Stokkers, Bathmen (NL); Evert Altena, Deventer (NL)

(73) Assignee: AKZO NOBEL CHEMICALS INTERNATIONAL B.V., Amersfoort (NL)

(21) Appl. No.: 13/265,774

(22) PCT Filed: Mar. 19, 2010
(86) PCT No.: PCT/EP2010/053638

§ 371 Date: Oct. 21, 2011

Related U.S. Application Data
(60) Provisional application No. 61/181,037, filed on May 26, 2009.

(30) Foreign Application Priority Data
Apr. 29, 2009 (EP) 09159049.7

(51) Int. Cl. A23L 1/237; A23L 1/30

(52) U.S. Cl. 426/62; 426/649; 426/302

(57) ABSTRACT

The present invention relates to a process to prepare a salt product containing sodium chloride (NaCl) and at least one additive, wherein the salt product has a particle size of from 50 μm to 10 mm, which process comprises the steps of: a) optionally, crushing a sodium chloride-containing material to a particle size that is between 1,000 times smaller and 3 times smaller than the size of the final salt product; b) optionally, crushing the at least one additive starting material to a particle size that is between 0.5 and 2 times the particle size of the sodium chloride-containing material particles resulting from step a.); c) subsequently, mixing the sodium chloride-containing material particles of a particle size that is between 1,000 times smaller and 3 times smaller than the size of the final salt product, and additive particles of a particle size that is between 0.5 and 2.0 times the particle size of the sodium chloride-containing material particles; d) subsequently, compacting the particle mixture resulting from step c.) using a pressure of from 40 to 400 MPa; e. subsequently, crushing the compacted salt product to give particles of the desired particle size of 50 μm to 10 mm; wherein the steps are carried out under substantially dry conditions. Additionally, the invention provides the low sodium salt product obtainable by the process and the use thereof for human or animal consumption.

The present invention relates to a process to prepare a low sodium salt product, to products obtainable by the process, and to the use thereof.

Among other reasons, sodium chloride is used in foods for its particular taste and its taste-enhancing properties. There is a need to reduce human sodium intake, as a too high sodium intake is thought to be related to a number of health problems. Therefore, in a number of salt products part of the sodium chloride is being replaced with other mineral salts, like potassium chloride. Potassium chloride, however, is characterized by a more metallic and bitter taste than sodium chloride, which makes it less preferred for human consumption. Alternatively, actual sodium intake can be lowered via products, sometimes partly based on sodium chloride, that generate a strong salt taste sensation and so ensure that less of the product needs to be consumed for a similar taste and taste-enhancing effect. This is for example disclosed in WO 2004/075663.

It is common practice to add functional additives and/or nutrients, like iodine or fluoride, to salt products. Also, it is known to mask the unpleasant taste of sodium chloride-replacing materials like potassium chloride by the addition of further additives, so-called masking agents, to low sodium salt products that contain such sodium chloride-replacing materials. Finally, it is known to add taste enhancers to sodium chloride based salt products to enhance the sodium chloride taste effect.

The additives added to sodium chloride based products can have a smaller particle size than sodium chloride and potassium chloride raw materials, especially where they concern organic additives. For example, yeast based additives have a particle size which is significantly below 100 microns, while sodium chloride and potassium chloride as industrially available generally have a particle size of a few hundred microns. If these two materials are mixed, demixing will occur upon transport and storage. Agglomeration is a way to avoid such demixing. However, after compacting and crushing to the desired particle size, the smaller particles will end up on the outer surface of the particles, resulting in loss of the additive.

Besides, as many additives have other properties than sodium chloride and sodium chloride-replacing materials like potassium chloride, from a processing point of view it is better to avoid them being located for the major part on the outer surface of the end product. For example, a number of additives are more hygroscopic than sodium chloride and potassium chloride, which results in the salt product showing a more hygroscopic behaviour when the additive particles are located on the outer surface than when they are entrapped and homogeneously mixed through the salt product.

A process to prepare a low sodium salt product is known from WO 2003/068006.

This document discloses a granulated salt product of sodium chloride and other mineral salts like potassium chloride, calcium chloride or magnesium chloride, and optionally further additives. The process to prepare the salt product includes the step of mixing salt fines of a size of less than 200 microns with the optional ingredients, adding 5 to 15 wt % of water, and then granulating the mass, for example by extruding or compacting. The process may be completed by the optional steps of drying and breaking the product to a particle size of 150 to 2,000 microns.

This process is disadvantageous, as it comprises a step of adding water and a later step of removing water to obtain a salt product in particulate form. Furthermore, the indicated processes generally will produce particles that are vulnerable to attrition.

U.S. 2009/0104330 discloses a reduced sodium salty taste composition for reduction of sodium chloride in food. The composition contains sodium chloride, at least one of a food acid and a salt of a food acid, at least one of an amino acid and a salt of an amino acid, and can additionally contain potassium chloride, yeast extract, sweeteners, and flavours. The composition is said to have a reduced metallic/bitter taste, to enhance the salty character, and to increase the intensity of the salty taste. The compositions, though many techniques to prepare them are listed if larger or smaller particles are desired, can be seen to be prepared by straight blending of the components. As the food acid, amino acid, yeast extract, sweeteners, and flavour additives added to the sodium chloride based products in

U.S. 2009/0104330 indeed generally have a significantly smaller particle size than sodium chloride and potassium chloride, it is expected that the compositions as prepared in U.S. 2009/0104330 will easily demix—for example upon transport and storage—as explained above, which leads to products having a different composition than intended, which in turn affects the functionality of the composition.

The purpose of the invention is to find an improved process that is more efficient and that results in a homogeneous low sodium salt product that does not have the above-indicated disadvantages.

We have now found an improved process that is more (energy) efficient and that results in a low sodium salt product with an improved taste in which the additives are homogeneously mixed with the sodium chloride, and optionally sodium chloride-replacing material, and included in the individual grains.

The present invention provides a process to prepare a (low sodium) salt product containing sodium chloride (NaCl) and at least one additive, wherein the salt product has a particle size of from 50 μm to 10 mm, which process comprises the steps of:
a. optionally, crushing a sodium chloride-containing material to a particle size that is between 1,000 times and 3 times smaller than the size of the final salt product;
b. optionally, crushing the at least one additive starting material to a particle size that is between 0.5 and 2 times the particle size of the sodium chloride-containing material particles of step a.);
c. subsequently, mixing the sodium chloride-containing material particles of a particle size that is between 1,000 times smaller and 3 times smaller than the size of the final salt product, and additive particles of a particle size that is between 0.5 and 2.0 times the particle size of the sodium chloride-containing material particles;
d. subsequently, compacting the particle mixture resulting from step c.) using a pressure of from 40 to 400 MPa;
e. subsequently, crushing the compacted salt product to give particles of the desired particle size of 50 μm to 10 mm;
wherein the steps are carried out under substantially dry conditions.

Additionally, the present invention provides the low sodium salt product obtainable by the process of the present invention and the use thereof for human and animal consumption.

It should be noted that GB 1 058 826 discloses an alkaline fully sodium-based salt product that may be obtained by subsequently compacting and crushing a mixture of sodium chloride and other sodium salts. The salt products obtained are alkaline salt products that find use in meat curing. GB 1 058 826 relates neither to salt products containing additives suitable for human consumption, nor to salt products in which the sodium content is lowered. Additionally, the salt products disclosed in this document do not contain any additive that is organic or has a taste-enhancing functionality.

Furthermore, it should be noted that JP 2006-169264 discloses a process to prepare a dialysis salt product containing acid and sugar components and an electrolyte, e.g. potassium chloride, that is prepared by mixing a first composition containing sodium chloride and an electrolyte coating layer and a second composition comprising nucleic particles containing a sugar component covered with a coating layer comprising the same or another sugar component and acids. JP2006-169264 compares this method to prepare the dialysis salt with a few other methods, one of which is disclosed in Comparative Example 2 involving the pulverization of a mixture containing sodium chloride, potassium chloride, and glucose to an average particle diameter of 50 μm, subsequently granulating the mixture with a roller compacter to give a granule with an average particle diameter of 500 μm, and concludes that such method is less preferred to give an aqueous dialysis salt products having a stable content. This document does not disclose a crushing step subsequent to the compaction step. Besides, it relates to the preparation of a dialysis salt wherein e.g. the homogeneity in small quantities of dry salt particles is not an issue but rather the homogeneity of large quantities of aqueous salt solution; in fact, this document teaches away from a process in accordance with the present invention wherein crushing and compacting takes place under substantially dry conditions.

The product obtainable by the process is indeed characterized by a more homogeneous mixing of the additive into the sodium chloride-containing particles and has good segregation and attrition resistance besides. Indeed, any undesired side-effect an additive may give to the salt product is reduced as the additive is (at least partly) entrapped into the salt product.

In this application the low sodium salt product is defined as encompassing both products in which part of the sodium chloride is replaced by other mineral salts, herein also referred to as sodium chloride-replacing materials, like potassium chloride (in this embodiment the material containing the sodium chloride and the sodium chloride-replacing material(s) is referred to as “sodium-chloride containing material”) and that contain at least one additive (like a taste enhancer, masking agent, nutrient or any other additive), and products based on sodium chloride that generate a strong salt taste sensation by the addition of an additive that functions as a so-called taste enhancer, ensuring that the same taste effect is experienced with a lower amount of sodium chloride, and combinations of the two above products.

It should be understood that materials specified to have a specific particle size are seldom composed of only particles having the same particle size. In this respect where a (salt) product or any other material in this specification is specified to have a certain particle size, it is generally accepted by the persons skilled in the art that for particle size should be read the average particle size or d₅₀ of a product in accordance with ISO 13320:2009.

The additive that can be added to the salt product using the process of the invention can be any material suitable for human or animal consumption or food- or feed-grade additive that on addition to the salt product using the process of the invention will not cause the salt product and the intermediate sodium chloride-containing material to no longer constitute a substantially dry form. The additive is not sodium chloride and also not the same material as the sodium chloride-replacing material. Materials that are suitable for human or animal consumption are, in an embodiment, materials that are allowed by the relevant authorities to be added to human food and animal feed products. Preferably, the additive is an organic additive.

Substantially dry in this application means having a free water content of below 3 wt %, preferably of below 1 wt %, on the basis of (total) solids. Free water means any water that can be evaporated (from the particles) at 100° C.

The (organic) additive in one embodiment is selected from the group of materials that suppress, enhance, influence or change the taste and/or flavour, or materials that influence the caking properties, free flowability, colour, texture, microbial stability, odour or nutritional value of the salt product or the food product in which the salt product of the present invention may be used. Organic means that the additive is a hydrocarbon based material or derivative thereof and means that it is preferably derived from a natural source.

In an even more preferred embodiment the additive is a taste/flavour enhancer, a taste/flavour masking agent (e.g. to mask the unpleasant (bitter or metallic) taste of sodium chloride-replacing materials), an anti-caking agent or a flow additive. In a most preferred embodiment the additive is a taste/flavour enhancer or taste/flavour masking agent. As the two groups of taste-enhancing and taste-masking agents often overlap, in this document they are collectively referred to as simply “taste enhancers”.

The taste enhancer can be selected from materials known to the person skilled in the art. Examples of materials that are suitable as a taste enhancer can be found in e.g. WO 2004/075663.

In one embodiment the above masking and taste-improving agents can be selected from the group of acids, such as succinic acid and citric acid; amino acids and derivates thereof, like glutamates; yeast; yeast extracts; hydrolyzed proteins from sources like yeast extracts; peptides; hydrolyzed vegetable protein; hydrolyzed fats; ribonucleotides; flavonoids; amides of amino acids with dicarboxylic acids; trehalose; gluconates and other flavouring agents and flavour-modulating substances, or combinations thereof. Other examples include organic acids like lactic acid, malic acid; salts of organic acids; the salts of ribonucleotides; products from the Maillard reaction and fermented foods, like soy sauce, fish sauce, anchovies, and cheese.

Flavouring agents are known to the person skilled in the art and can for example be found in S. Arctander, Perfume and Flavor Chemicals (Aroma Chemicals), Vols. 1 and 2, 1969. The term flavouring agent includes spice oleoresins and oils derived from any of allspice, basil, capsicum, cinnamon, cloves, cumin, dill, garlic, marjoram, nutmeg, paprika, black pepper, rosemary, and turmeric; essential oils including anise oil, caraway oil, clove oil, eucalyptus oil, fennel oil, garlic oil, ginger oil, peppermint oil, onion oil, pepper oil, rosemary oil, and spearmint oil; citrus oils such as orange oil, lemon oil, bitter orange oil and tangerine oil; alliaceous flavours including garlic, leek, chive, and onion; botanical extracts including arnica flower extract, chamomile flower extract, hops extract, and marigold extract; botanical flavour extracts including blackberry, chicory root, cocoa, coffee, kola, licorice root, rose hips, sassaparilla root, sassafras bark, tamarind, licorice, and vanilla extracts; protein hydrolysates including hydrolyzed vegetable protein (HVPs), meat protein hydrolysates, milk protein hydrolysates; compounded flavours both natural and artificial including those disclosed in S. Heath, Source Book of Flavors, Avi Publishing Co. Westport, Conn., pp. 149-277, 1981, which is incorporated herein by reference in its entirety; and processed (reaction) flavours prepared through a Maillard-type reaction between reducing sugars and protein-derived components including amino acids.

Representative individual flavouring agents include benzaldehyde, diacetyl (2,2-butanedione), vanillin, ethyl vanillin and citral (3,7-dimethyl-2,6-octadienal).

The salt product of the process of the invention preferably consists of free-flowing particles.

In one embodiment the low sodium salt product of the invention is a product for human or animal consumption, preferably for human consumption.

In a preferred embodiment the low sodium salt product of the invention is not a dialysis salt made of combining 3,000 gr of NaCl, 73.3 g of KCl, 49.9 g of MgCl₂.6H₂O, 90.3 g of CaCl₂.2H₂O, 221.6 gr of sodium acetate, and 491.2 gr of glucose having a particle diameter of 500 μm as disclosed in Comparative Example 2 of JP2006-169264. Even more preferably, the sodium salt product of the invention is not a dialysis salt at all.

In a preferred embodiment the sodium chloride-containing material additionally contains a sodium chloride-replacing material. The sodium chloride-replacing material is in an embodiment a mineral material that does not contain sodium chloride, preferably, it does not contain sodium.

In an even more preferred embodiment, the sodium chloride-replacing material is selected from the group of potassium chloride, magnesium chloride, calcium chloride, choline chloride, ammonium chloride, magnesium sulphate, and at least one (organic) additive is added to improve the taste and/or the taste-enhancing properties of the product or to mask the unpleasant taste of the sodium chloride-replacing material.

In a more preferred embodiment still, the sodium chloride-replacing material is potassium chloride and most preferably the salt product has a weight ratio of Na:K of from 80:20 to 20:80, most preferably of from 75:25 to 30:70.

In a preferred embodiment the particle size of the sodium chloride-containing material in step c.) is between 500 times smaller and 4 times smaller than the size of the final salt product, even more preferably, it is between 100 times smaller and 5 times smaller than the size of the final salt product.

It is worth noting that in some embodiments where there is a recycling of materials it is possible to start the process of the invention with particles that have a particle size that is somewhat outside the range of between 1,000 times and 3 times smaller than the particle size of the final salt product as required in step c.). In such embodiments, wherein the process is performed so that the materials on average recycle one or more times through the several process steps, the components undergo several compacting and crushing steps, whereby their particle size decreases, before they are withdrawn from the process in the final salt product. Consequently, the process can also be performed with particles that have a particle size of between 3 times smaller and 2 times smaller than the particles size of the final salt product, as due to the on average one or more times recycling of all components, the average particle size of the components in step c.) is in effect within the ranges of step c.) and thus the process of the present invention.

The particle size of the sodium chloride-containing material and additive in step c.)

in yet another preferred embodiment is preferably between 10 and 100 μm. The final (low sodium) salt product preferably has a particle size of between 100 and 1,000 μm.

In a preferred embodiment in step c.) the additive particles have a particle size that is between 0.8 and 1.2 times the particle size of the sodium chloride-containing material particles.

The step of crushing as specified in steps a.), b.), and e.) is meant to include any method whereby the size of the particles is decreased and is intended to include methods like breaking, crushing, or milling.

It should be noted that the components can be crushed with two or more of them in one combined step or by separate crushing steps. If a sodium chloride-replacing material is used in the process, it can be crushed together with the sodium chloride or separately.

For reasons of process efficiency it is preferred to crush as many of the components in one crushing step as possible and, if reasonably feasible, it is even more preferred to crush all components in one single crushing step. In this even more preferred embodiment the steps a.) and b.) of the process of the invention can be combined into one step and in effect are carried out simultaneously with step c.) of the process of the invention as during the combined crushing the components are (often inherently) being mixed.

The pressure used for compacting the particle mixture in step d.) is the pressure applied at uniaxial compaction of a tablet (leading to a certain density of the compacted particle mixture). However, compacting may suitably be done by other compactors, like a roll compactor. In such cases, the pressure to be used is one that will result in the same density of the compact as in uniaxial compaction.

The step of compacting as specified in step d.) is meant to include any method where the particles are agglomerated by applying an external force, for instance by tabletting or agglomerating them under a pressure of from 40 to 400, preferably of from 40 to 200 MPa, more preferably a pressure of from 50 to 120 MPa, most preferably of from 75 to 100 MPa.

The sodium chloride-containing material can be of several different origins, like sea salt, rock salt, purified (vacuum) salt, or a synthetic salt origin.

The process of the invention in one embodiment can contain a subsequent step in which the material is sieved to isolate particles of the desired composition or to separate the particles of the desired particle size range(s) from too fine and too coarse particles. In such an embodiment, for example, after step e.) the material is sieved to remove too fine and/or too coarse particles from the salt product(s) and optionally these too fine and/or too coarse particles are recycled to the process in steps c.) and e.), respectively.

In a further embodiment of the process still, any extremely fine particles that may be formed as side product, often referred to as dust particles, are collected in a filter and recycled back to the process, preferably in step c.) or d.) thereof.

In one embodiment, (a) further additive(s) can be added to the salt product. In a preferred embodiment such further additive(s) can be selected from the group of vitamins, acids, yeasts, amino acids, functional additives or nutrients, like fluorides, iodides, iodates, minerals, nitrites, nitrates, flavouring agents, fragrances, saccharides, (natural) flavours, spices, or herbs.

In a preferred embodiment, in the process of the invention a further additive is sprayed onto the salt mixture obtained in step c.) or e.) of the process, more preferably onto the product of step e.), optionally after the product of step e.) has been sieved. This embodiment is particularly useful when there is a desire to add further additives to the salt product that are hard or impossible to isolate in a substantially dry form or much more easily processed or distributed in a liquid (or dissolved) form. This additional step of adding further additives may be followed by a drying step if needed.

In yet another preferred embodiment, in the process of the invention a further additive is mixed into the salt mixture obtained in step c.) or e.), more preferably into the product of step e.), optionally after the product of step e.) has been sieved. This further additive can be added in the presence of a liquid, which liquid may make the additive stick to the salt product. This additional step of adding further additive may be followed by a drying step if needed.

### EXAMPLES

### Example 1

Commercially available (purified quality) NaCl, KCl, and succinic acid were crushed in a mortar and sieved over a 90 μm screen. From the fractions passing the sieve 550 g NaCl (having a d₅₀ of 59 μm), 479.5 g KCl (having a d₅₀ of 36 μm), and 9.9 g succinic acid (having a d₅₀ of 58 μm) were taken and mixed thoroughly with 60.5 g of the yeast extract Maxarite™ Delite (having a d₅₀ of 58 μm) ex DSM Food Specialties BV. From this mixture 50 g tablets (40 mm diameter, ≈20 mm height) were made on a Herzog tablet press using 1.0 t/cm² pressure (which corresponds to a pressure of 100 MPa). The resulting tablets were broken diametrically and milled on a Frewitt sieving mill using a 6 mm, 3 mm, and finally a 1 mm screen. Product resulting from the Frewitt sieving mill was sieved into fractions using 710, 500, 280, and 90 μm screens. The fraction 280 to 710 μm (i.e two fractions combined) was further analyzed and established to have a d₅₀ of 396 μm.

### Example 2

The formulation of this example contains 70 wt % NaCl, 26 wt % KCl, and 4 wt % yeast extract Maxarite™ Delite. The NaCl and KCl were milled on the Alpine 160 UPZ pin mill operated at 5,700 rpm. The milled NaCl (d₅₀=69 μm) and KCl (d₅₀=58 μm) were charged together with unmilled Maxarite™ Delite (d₅₀=58 μm) in 1.5 kg batches to a 2-litre Nautamixer and mixed for at least 10 minutes at 19 rpm. The mixed powder was collected in a bin from which the Herzog tablet press was manually fed with 50 g portions. The applied pressure ranged from 0.5 t/cm² to 1.0 t/cm² (which corresponds to a pressure of 50 to 100 MPa). The majority of the tablets were compacted at 1.0 t/cm² pressure. The dimensions of most of the tablets were 40 mm diameter and ≈20 mm height. The resulting tablets were broken diametrically.

After preliminary breaking, further crushing of the tablets was done in 3 steps:
1. Merz toothed (pyramids) roller crusher with a diameter of 200 mm, roll distance 8.0 mm, roll speed 295 rpm (both rolls).
2. Merz smooth roller crusher with a diameter of 200 mm, roll distance 3.0 mm, roll speed 195 and 300 rpm. This means that the crusher is operated by friction.
3. Merz smooth roller crusher with a diameter of 200 mm, roll distance 1.0 mm, roll speed 195 and 300 rpm.

The oversized fraction after the final crushing step appeared to be large. Therefore, the product was crushed once more on the Merz smooth roller crusher, now operated at a 0.8 mm roll distance. The crushed product was sieved on the Mogensen Piccolo equipped with a 200 μm and a 710 μm screen.

The fraction 200 to 710 μm was further analyzed and established to have a d₅₀ of 455 μm.

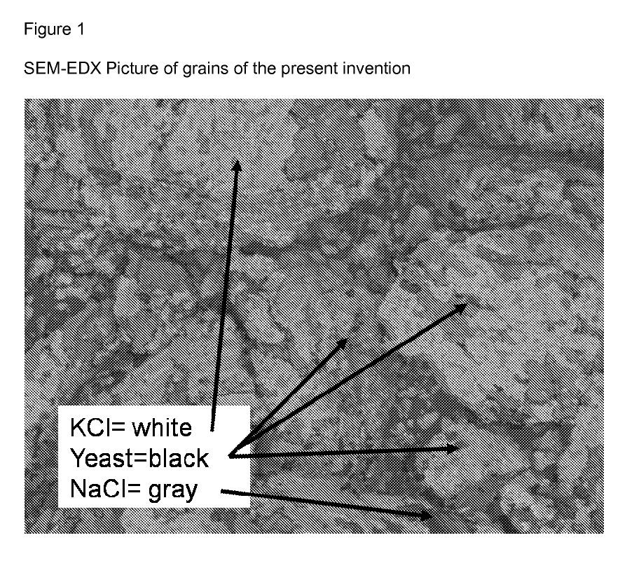

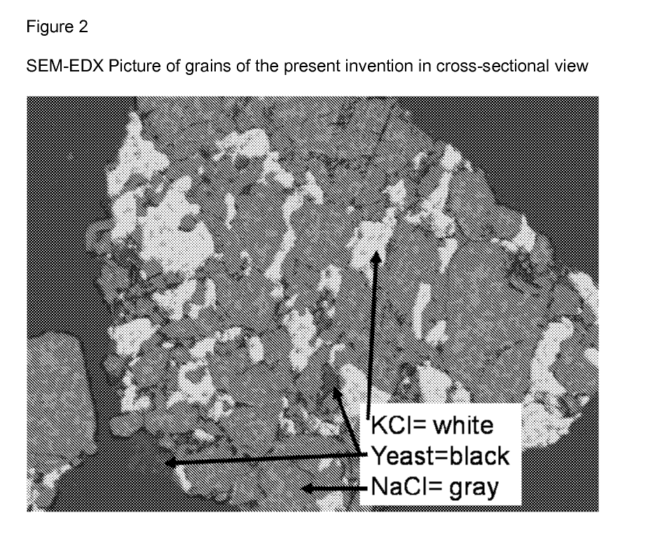

In FIGS. 1 and 2 pictures are shown of this fraction, wherein FIG. 2 is a cross-sectional view. The pictures were taken using SEM-EDX analysis (i.e. scanning electron microscope energy dispersive analysis of X-rays) to determine Na, K, Cl elemental and organic material distribution. The inner surfaces of the particles were analyzed by embedding the particles in a resin and carefully removing the upper layers of the particles. As can be seen in FIGS. 1 and 2, the product of Example 2 consists of particles that each have the individual components present. It is possible to identify the milled starting materials in the particle and it is clear that the components are evenly and homogeneously distributed in the particles, contrary to the sample of Comparative Example 4 below in which the yeast additive is preferentially present at the surface.

### Comparative Example 3

Purified quality NaCl (500 g, having a d₅₀ of 375 μm), KCl (436 g, having a d₅₀ of 296 μm), succinic acid (9 g, having a d₅₀ of 464 μm), and yeast extract Maxarite™ Delite (55 g having a d₅₀ of 58 μm) were taken and mixed thoroughly. From this mixture 50 g tablets (40 mm diameter, ≦20 mm height) were made on a Herzog tablet press. The applied pressure was 1.0 t/cm² (which corresponds to a pressure of 100 MPa). The resulting tablets were broken diametrically and milled on a Frewitt sieving mill using a 6 mm, 3 mm, and finally a 1 mm screen. Product resulting from the Frewitt sieving mill was sieved into fractions using 710, 500, 280, and 90 μm screens. The fractions below 90 μm, 90 to 280 μm (having a d₅₀ of 231 μm), 280 to 500 μm (having a d₅₀ of 381 μm), 500 to 710 μm (having a d₅₀ of 587 μm), and above 710 μm were examined.

The fractions showed very different taste and solubility properties. Chemical analysis of the 280-500 μm fraction showed significant deviations from the intended composition as the amount of NaCl was found to be 8% higher than expected, the amount of KCl 3% lower than expected, the amount of succinic acid 10% lower than expected, and the amount of Maxarite™ Delite 43% lower than expected on the basis of the amount of starting material used. Besides, the mixture used for the compaction showed a segregation tendency, thereby hindering proper handling in an industrial compaction process.

### Comparative Example 4

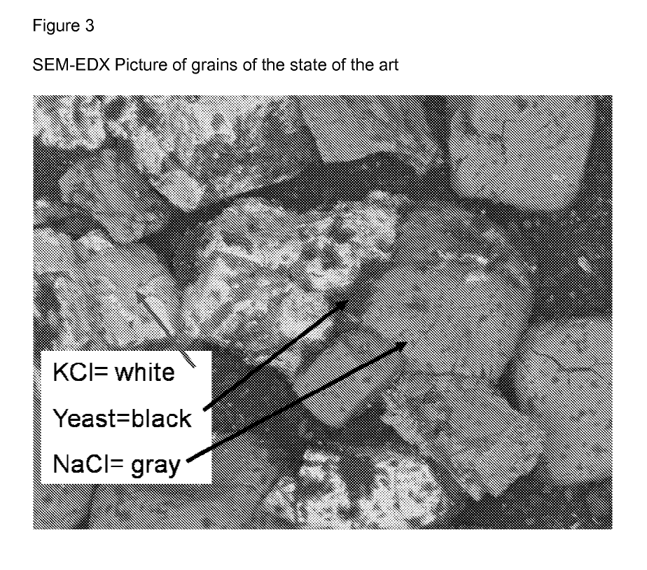

The formulation of this example contains 69 wt % NaCl, 26 wt % KCl, and 5 wt % yeast extract. The formulation was made using commercially available NaCl (d₅₀=375 μm) and KCl (d₅₀=296 μm). These components were charged together with an unmilled yeast extract having a d₅₀ of 86 μm and mixed. From this mixture 50 g tablets (40 mm diameter, ≈20 mm height) were made on a Herzog tablet press using 1.0 t/cm² pressure (which corresponds to a pressure of 100 MPa). The resulting tablets were broken diametrically and milled on a Frewitt sieving mill using a 6 mm, 3 mm, and finally a 1 mm screen. Particles of the fractions 90-200 μm and 200-710 μm were analyzed for component distribution. In FIG. 3 a picture is shown of the 200 to 710 μm fraction of this Comparative Example 4, using SEM-EDX analysis, scanning electron microscope energy dispersive analysis of X-Rays, to determine Na, K, Cl elemental and organic material distribution. As can be seen in FIG. 3, the yeast particles appear to be primarily present on the outer surface of sodium chloride and potassium chloride particles. Moreover, it can be seen that the particles made in this Comparative Example to a very large extent consist of the primary particles that were used as starting material. In other words, crushing has taken place primarily via the original particle surfaces, thereby freeing particles of the original individual components, i.e. NaCl and KCl and yeast extract. Because of this last observation it is expected that the yeast extract particles are located solely on the surfaces of the original KCl and NaCl starting material particles and that the process of this Comparative Example 4 does not result in homogeneous particles containing all the ingredients as in Example 2 but instead in mainly separate NaCl and KCl particles containing clumps of yeast extract on their surface.

1-13. (canceled)

14. A process to prepare a salt product containing sodium chloride (NaCl) and at least one additive, wherein the salt product has a particle size of from 50 μm to 10 mm, the process comprising the steps of:
c. mixing a sodium chloride-containing material of a particle size that is between 1,000 times smaller and 3 times smaller than the size of the final salt product, and additive particles of a particle size that is between 0.5 and 2.0 times the particle size of the sodium chloride-containing material particles;
d. subsequently, compacting the particle mixture resulting from step c.) using a pressure of from 40 to 400 MPa; and
e. subsequently, crushing the compacted salt product to give particles of the desired particle size of 50 μm to 10 mm;
wherein the steps are carried out under substantially dry conditions;
wherein the sodium chloride-containing material additionally contains a sodium chloride-replacing material, and the sodium chloride-replacing material is selected from the group consisting of potassium chloride, magnesium chloride, calcium chloride, choline chloride, ammonium chloride, and magnesium sulphate; and wherein at least one additive is added to improve the taste and/or the taste-enhancing properties of the product or to mask the unpleasant taste of the sodium chloride-replacing material.

15. The process of claim 14, further comprising at least one of the following steps:
a. crushing a sodium chloride-containing material to a particle size that is between 1,000 times smaller and 3 times smaller than the size of the final salt product; and
b. crushing the at least one additive starting material to a particle size that is between 0.5 and 2 times the particle size of the sodium chloride-containing material particles resulting from step a.);
wherein steps a.) and/or b.) precede or are carried out simultaneously with step c.).

16. The process of claim 14, wherein the at least one additive is an organic additive.

17. The process of claim 15, wherein the at least one additive is a taste enhancer.

18. The process of claim 14, wherein the sodium chloride-replacing material is potassium chloride, and the salt product has a weight ratio of Na:K of 80:20 to 20:80.

19. The process of claim 14, wherein the at least one additive is an additive suitable for human or animal consumption that can be isolated in a substantially dry form.

20. The process of claim 19, wherein the at least one additive is selected from the group consisting of succinic acid; citric acid; amino acids and derivates thereof; glutamates; yeast; yeast extracts; hydrolyzed proteins; peptides; hydrolyzed vegetable protein; hydrolyzed fats; ribonucleotides; flavonoids; amides of amino acids with dicarboxylic acids; trehalose; gluconates; and combinations thereof.

21. The process of claim 14, wherein after step e.) the material is sieved to remove too fine and/or too coarse particles from the salt product, and these too fine and/or too coarse particles are recycled to the process in steps c.) and e.), respectively.

22. The process of claim 14, wherein a further additive is sprayed onto the product or mixed into the salt mixture of step c.) or e.).

23. A low-sodium salt product obtained by the process according to claim 14.

24. A food product comprising:
a human food product or an animal feed product; and
the low sodium salt product of claim 23.

25. The process of claim 15, wherein the at least one additive is an organic additive.

26. The process of claim 16, wherein the at least one additive is a taste enhancer.

27. The process of claim 15, wherein the at least one additive is an additive suitable for human or animal consumption that can be isolated in a substantially dry form.

28. The process of claim 18, wherein the at least one additive is an additive suitable for human or animal consumption that can be isolated in a substantially dry form.

29. The process of claim 27, wherein the at least one additive is selected from the group consisting of succinic acid; citric acid; amino acids and derivates thereof; glutamates; yeast; yeast extracts; hydrolyzed proteins; peptides; hydrolyzed vegetable protein; hydrolyzed fats; ribonucleotides; flavonoids; amides of amino acids with dicarboxylic acids; trehalose; gluconates; and combinations thereof.

30. The process of claim 28, wherein the at least one additive is selected from the group consisting of succinic acid; citric acid; amino acids and derivates thereof; glutamates; yeast; yeast extracts; hydrolyzed proteins; peptides; hydrolyzed vegetable protein; hydrolyzed fats; ribonucleotides; flavonoids; amides of amino acids with dicarboxylic acids; trehalose; gluconates; and combinations thereof.

31. The process of claim 20, wherein after step e.) the material is sieved to remove too fine and/or too coarse particles from the salt product, and these too fine and/or too coarse particles are recycled to the process in steps c.) and e.), respectively.

32. The process of claim 15, wherein a further additive is sprayed onto the product or mixed into the salt mixture of step c.) or e.).

33. A low-sodium salt product obtained by the process according to claim 18.
